(19) United States
(12) Patent Application Publication
(10) Pub. No.: US 2024/0307264 A1
(43) Pub. Date: Sep. 19, 2024

(54) MANUFACTURING METHOD OF MASSAGE DEVICE AND MASSAGE DEVICE

(71) Applicant: LEISHENG YAN, NANYANG CITY (CN)

(72) Inventor: LEISHENG YAN, NANYANG CITY (CN)

(21) Appl. No.: 18/324,128

(22) Filed: May 25, 2023

(30) Foreign Application Priority Data
Mar. 15, 2023 (CN) 202310314931.8

(51) Int. Cl. A61H 23/02; B29C 45/16

(52) U.S. Cl. CPC A61H 23/02; B29C 45/1671; B29C 45/14065; B29C 45/14491; B29C 65/48; B29L 2031/753

(57) ABSTRACT

A manufacturing method of a massage device and a massage device are provided. The method includes S10: preparing materials; S20: assembling a first mold core into an outer mold; S30: injecting a soft outer body raw material into the outer mold; S40: after the soft outer body raw material is shaped, taking out the first mold core; S50: coating a front end and a rear end of an exterior of a bushing with an adhesive, and fully adhering the bushing to a front end and a rear end of the first cavity through the bushing inserting jig; S60: injecting a soft filler raw material into the bushing; S70: placing a suction cup forming mold on a top of the outer mold; S80: placing a shaped product in an oven for baking; and S90: injecting lubricating oil into the enclosed space formed between the bushing and the first cavity.

### FIELD OF THE DISCLOSURE

The present disclosure relates to massagers, and more particularly to a manufacturing method of a massage device and a massage device.

### BACKGROUND OF THE DISCLOSURE

With the improvement of people's living standards, the requirements for the functions and user experience of auxiliary equipment are getting higher and higher. The massager is a new generation of health care equipment developed based on physics, bionics, bioelectricity, traditional Chinese medicine and many years of clinical practice.

Existing massage devices are limited by materials and manufacturing methods, so that the production and processing process of the product is relatively cumbersome, and the product structure of production and design is simple, and the comfort level is average in use. Therefore, it needs to be improved.

### SUMMARY OF THE DISCLOSURE

The object of the present disclosure is to address the defects and deficiencies of the prior art, and provide a manufacturing method of a massage device and a massage device, which solve at least one of the above-mentioned problems, and the manufactured massage device has the advantage of high massage comfort.

In order to achieve the above object, the technical solution adopted by the present disclosure is to provide a manufacturing method of a massage device, including the following steps: step S10: preparing an outer mold, a first mold core, a suction cup forming mold, a bushing inserting jig, a bushing, a soft outer body raw material, a soft filler raw material, an adhesive and a lubricating oil; step S20: assembling the first mold core into the outer mold; step S30: injecting the soft outer body raw material into the outer mold; step S40: after the soft outer body raw material is shaped, taking out the first mold core, the soft outer body raw material forming a soft outer body, and a first cavity is formed at an original position of the first mold core; step S50: coating each of a front end and a rear end of an exterior of the bushing with the adhesive, fully adhering the bushing correspondingly to a front end and a rear end of the first cavity through the bushing inserting jig, so that an enclosed space is formed between the bushing and the first cavity, and taking out the bushing inserting jig; step S60: injecting the soft filler raw material into the bushing for filling; step S70: placing the suction cup forming mold on a top end of the outer mold to form a suction cup shape on a top end of the soft filler raw material; step S80: placing a shaped product in an oven for baking; and step S90: injecting the lubricating oil into the enclosed space formed between the bushing and the first cavity.

In preferred embodiments, step S10 further includes preparing a positioning device, a vibration motor, a control device and a power supply unit; the method further includes step S51 between step S50 and step S60, and step S51 includes assembling the vibration motor, the control device, and the power supply unit to a lower side of a positioning jig, and placing the positioning jig on the top end of the outer mold, so that the vibration motor, the control device, and the power supply unit are placed in the bushing without contacting with the bushing; the method further includes step S61 between step S60 and step S70, and step S61 includes taking off the positioning jig.

In preferred embodiments, step S10 further includes preparing a second mold core and a ball; step S20 includes assembling the first mold core and the second mold core into the outer mold; step S40 includes, after the soft outer body raw material is shaped, taking out the first mold core and the second mold core, the soft outer body raw material forming the soft outer body, the first cavity being formed at an original position of the first mold core, and a second cavity being formed at an original position of the second mold core; step S60 includes injecting the soft filler raw material into the bushing for filling, and filling to an upper end of the bushing; the method further includes step S61 and step S62 between step S60 and step S70, step S61 includes putting the ball into a the second cavity that is preformed and step S62 includes injecting the soft filler raw material into a cavity in the bushing that has not been injected with the soft filler raw material.

In preferred embodiments, step S10 further includes preparing a positioning device, a vibration motor, a control device, a power supply unit, a second mold core and a ball; step S20 includes assembling the first mold core and the second mold core into the outer mold; step S40 includes, after the soft outer body raw material is shaped, taking out the first mold core and the second mold core, the soft outer body raw material forming the soft outer body, the first cavity being formed at an original position of the first mold core forming, and the second cavity being formed at an original position of the second mold core; the method further includes step S51 between step S50 and step S60, and step S51 includes assembling the vibration motor, the control device, and the power supply unit to a lower side of a positioning jig, and placing the positioning jig on the top end of the outer mold, so that the vibration motor, the control device, and the power supply unit are placed in the bushing without contacting with the bushing; step S60 includes injecting the soft filler raw material into the bushing for filling, and filling to an upper end of the bushing; wherein the method further includes step S61, step S62 and step S63 between step S60 and step S70, step S61 includes removing the positioning jig, step S62 includes putting the ball into the second cavity that is preformed, and step S63 includes injecting the soft filler raw material into a cavity in the bushing that has not been injected with the soft filler raw material.

In preferred embodiments, in step S80, a baking temperature is 80 degrees Celsius to 90 degrees Celsius.

In preferred embodiments, step S90 further includes providing pinholes on the bushing or the first cavity, and injecting the lubricating oil into the enclosed space formed between the bushing and the first cavity through the pinholes.

In preferred embodiments, the manufacturing method of the massage device further includes step S100, and step S100 includes enclosing the pinholes.

In preferred embodiments, the bushing is made of a bushing mold.

In preferred embodiments, a bottom end of the outer mold corresponds to a massage end of the massage device, and the top end of the outer mold corresponds to a handheld end of the massage device; the control device is assembled to the lower side of the positioning jig, the vibration motor is connected to a lower side of the control device through wires, and the power supply unit is fixedly assembled on the control device; the control device is provided with a charging electrode, and the charging electrode faces the top end of the outer mold; and wherein the control device is provided with a push switch, and the push switch faces a side of the outer mold.

In preferred embodiments, the positioning jig is provided with a positioning structure, so that the control device is detachably assembled on the lower side of the positioning jig, and maintains the charging electrode facing the top end of the outer mold.

In preferred embodiments, a top side of the outer mold is provided with a socket, a lower side of the first mold core is provided with an insert post, and the insert post is detachably inserted into the socket; a notch is provided on the top side of the outer mold, and a first protrusion protruding outward and corresponding to the notch is provided on the positioning jig.

In preferred embodiments, a first handle is provided on a top side of the first mold core.

In preferred embodiments, the suction cup forming mold is provided with a second protrusion protruding outwards and corresponding to the notch, and a top side of the suction cup forming mold is provided with a second handle.

In preferred embodiments, a bottom end of the suction cup forming mold is provided with a third protrusion, so that after the suction cup forming mold is placed on the top end of the outer mold, a charging port is formed on a handheld end of the massage device, and the charging port corresponds to the charging electrode.

In preferred embodiments, the bottom end of the suction cup forming mold is in an arc shape protruding outward, so that a bottom end of the handheld end of the massage device is in an arc shape protruding inward.

In preferred embodiments, the second mold core includes a frame body for erecting on an upper side of the outer mold, and a knot protrusion structure arranged on the frame body for forming the second cavity.

In order to achieve the above object, another technical solution adopted by the present disclosure is to provide a massage device manufactured based on a manufacturing method of a massage device as mentioned above.

In preferred embodiments, the massage device further includes: a soft outer body having a first cavity; a bushing disposed in the first cavity, wherein an enclosed space is formed between an exterior of the bushing and the first cavity; two adhesive members, wherein one adhesive member is adhered between a front end of the exterior of the bushing and the first cavity, and another adhesive member is adhered between a rear end of the exterior of the bushing and the first cavity; a lubricating oil layer filled in the enclosed space; and a soft filler filled in the bushing.

In preferred embodiments, the massage device further includes a vibration motor located in the bushing; a control device located in the bushing and electrically connected to the vibration motor, and configured to control operation of the vibration motor; and a power supply unit located in the bushing and electrically connected to the control device, and configured to supply power correspondingly to the vibration motor and the control device; the soft filler encloses the vibration motor, the control device and the power supply unit in the bushing.

In preferred embodiments, the soft outer body is provided with a second cavity, and the massage device further includes a ball located in the second cavity.

The present disclosure further provides that the soft outer body has the second cavity; the massage device further includes the ball located in the second cavity.

After adopting the above-mentioned technical solution, the beneficial effect of the present disclosure is as follows.

1. In the present disclosure, by providing the bushing, inserting the bushing into the jig to fully bond the bushing to the front end and the end of the first cavity, an enclosed space is formed between the bushing and the first cavity. After molding, lubricating oil is injected into the enclosed space formed by the bushing and the first cavity to improve product functions, making massage more comfortable and bringing users a better experience.

2. In the present disclosure, the vibration motor and the control device do not require additional shells or brackets for support and protection, and are directly placed in the first cavity of the soft outer body, and then filled with soft fillers. Since there is no shell or bracket, the foreign body feeling of the product is greatly reduced, and the user experience is improved.

### BRIEF DESCRIPTION OF THE DRAWINGS

In order to more clearly illustrate the embodiments of the present disclosure or the technical solutions in the prior art, the following will briefly introduce the drawings that need to be used in the description of the embodiments or the prior art. Obviously, the accompanying drawings in the following description are only some embodiments of the present disclosure. For those skilled in the art, other drawings can also be obtained according to these drawings on the premise of not paying creative efforts.

FIG. 1 is a schematic structural diagram of a massage device;

FIG. 2 is a schematic three-dimensional structural diagram of the massage device;

FIG. 3 is a schematic structural diagram of a vibration motor, a control device, a power supply unit, an outer mold, a first mold core, and a positioning jig;

FIG. 4 is a schematic structural diagram showing the first mold core is assembled into the outer mold;

FIG. 5 is a schematic structural diagram showing the first mold core is taken out;

FIG. 6 is a schematic structural diagram showing the positioning jig is placed on a top end of the outer mold;

FIG. 7 is a schematic structural diagram showing the positioning jig is taken out;

FIG. 8 is a schematic structural diagram showing a suction cup forming mold is placed on the top end of the outer mold;

FIG. 9 is a schematic structural diagram showing the suction cup forming mold is taken out;

FIG. 10 is a schematic structural diagram of the suction cup forming mold;

FIG. 11 is a schematic diagram of steps of a first manufacturing method of the massage device;

FIG. 12 is a schematic diagram of steps of a second manufacturing method of the massage device;

FIG. 13 is a schematic diagram of steps of a third manufacturing method of the massage device; and

FIG. 14 is a schematic diagram of steps of a fourth manufacturing method of the massage device.

Reference numeral: 100, massage device; 110, soft outer body; 120, vibration motor; 130, control device; 140, power supply unit; 150, wires; 160, charging electrode; 170, charging port; 180, push switch; 190, bushing; 200, outer mold; 210, socket; 220, notch; 300, first mold core; 310, insert post; 320, first handle; 400, positioning jig; 410, first protrusion; 420, positioning structure; 500, suction cup forming mold; 510, second protrusion; 520, second handle; 530, third protrusion; a, massage end; b, handheld end; c, first cavity; d, enclosed space; e, lubricating oil layer; f, soft filler.

### DETAILED DESCRIPTION OF THE EXEMPLARY EMBODIMENTS

The present disclosure will be described in further detail below in conjunction with the accompanying drawings.

This specific embodiment is only an explanation of the present disclosure, and it is not a limitation of the present disclosure. After reading this specification, those skilled in the art can make modifications to this embodiment without creation contribution as required, and as long as they are within the scope of the claims of the present disclosure, they are all protected by the patent law.

The present embodiment relates to a manufacturing method of a massage device. Four embodiments are listed below.

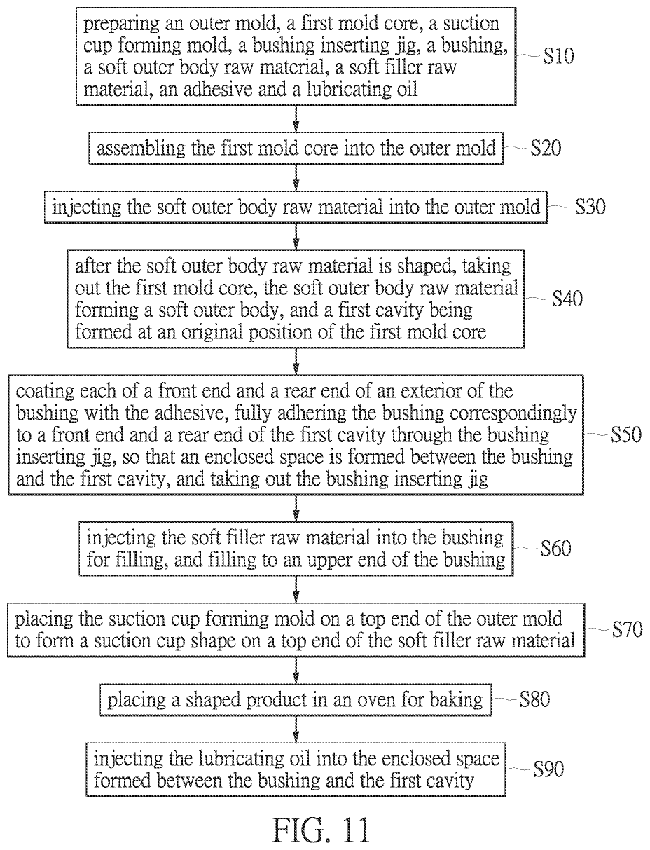

Embodiment 1 is shown in FIG. 11.

The method in the present embodiment includes the following steps: step S10: preparing an outer mold, a first mold core, a suction cup forming mold, a bushing inserting jig, a bushing, a soft outer body raw material, a soft filler raw material, an adhesive and a lubricating oil; step S20: assembling the first mold core into the outer mold; step S30: injecting the soft outer body raw material into the outer mold; step S40: after the soft outer body raw material is shaped, taking out the first mold core, the soft outer body raw material forming a soft outer body, and a first cavity is formed at an original position of the first mold core forming; step S50: coating each of a front end and a rear end of an exterior of the bushing with the adhesive, fully adhering the bushing correspondingly to a front end and a rear end of the first cavity through the bushing inserting jig, so that an enclosed space is formed between the bushing and the first cavity, and taking out the bushing inserting jig; step S60: injecting the soft filler raw material into the bushing for filling; step S70: placing the suction cup forming mold on a top end of the outer mold to form a suction cup shape on a top end of the soft filler raw material; step S80: placing a shaped product in an oven for baking; and step S90: injecting the lubricating oil into the enclosed space formed between the bushing and the first cavity.

More specifically, in step S80: a baking temperature is 85 degrees Celsius. In other embodiments, the baking temperature can also be 80 degrees Celsius, 90 degrees Celsius, etc., preferably within the closed range of 80 degrees Celsius to 90 degrees Celsius.

In order to be able to inject the lubricating oil into the enclosed space formed between the bushing and the first cavity through a pinhole, the pinhole is firstly provided on the bushing. Of course, in other embodiments, the pinhole may also be provided on the first cavity.

On this basis, the pinhole can also be enclosed, and it is not necessary to perform the process of enclosing when it is hot.

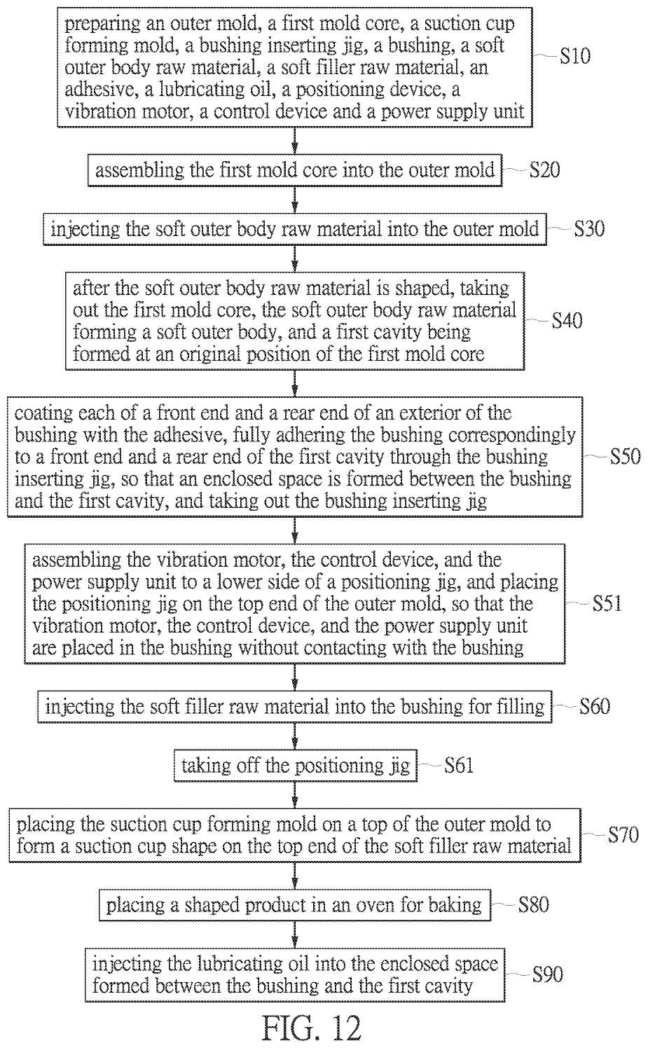

Embodiment 2 is shown in FIG. 12.

The method in the present embodiment includes step S10: preparing an outer mold, a first mold core, a suction cup forming mold, a bushing inserting jig, a bushing, a soft outer body raw material, a soft filler raw material, an adhesive and a lubricating oil; step S20: assembling the first mold core into the outer mold; step S30: injecting the soft outer body raw material into the outer mold; step S40: after the soft outer body raw material is shaped, taking out the first mold core, the soft outer body raw material forming a soft outer body, and a first cavity is formed at an original position of the first mold core; step S50: coating each of a front end and a rear end of an exterior of the bushing with the adhesive, fully adhering the bushing correspondingly to a front end and a rear end of the first cavity through the bushing inserting jig, so that an enclosed space is formed between the bushing and the first cavity, and taking out the bushing inserting jig; step S51: assembling the vibration motor, the control device, and the power supply unit to a lower side of a positioning jig, and placing the positioning jig on the top end of the outer mold, so that the vibration motor, the control device, and the power supply unit are placed in the bushing without contacting with the bushing; step S60: injecting the soft filler raw material into the bushing for filling; step S61: taking off the positioning jig; step S70: placing the suction cup forming mold on a top end of the outer mold to form a suction cup shape on the top end of the soft filler raw material; step S80: placing a shaped product in an oven for baking; and step S90: injecting the lubricating oil into the enclosed space formed between the bushing and the first cavity.

More specifically, in step S80: a baking temperature is 85 degrees Celsius. In other embodiments, the baking temperature can also be 80 degrees Celsius, 90 degrees Celsius, etc., preferably within the closed range of 80 degrees Celsius to 90 degrees Celsius.

In order to be able to inject lubricating oil into the enclosed space formed between the bush and the first cavity through a pinhole, the pinhole is firstly provided on the bushing. Of course, in other embodiments, the pinhole may also be provided on the first cavity.

On this basis, the pinholes can also be enclosed, and it is not necessary to perform the process of enclosing when it is hot.

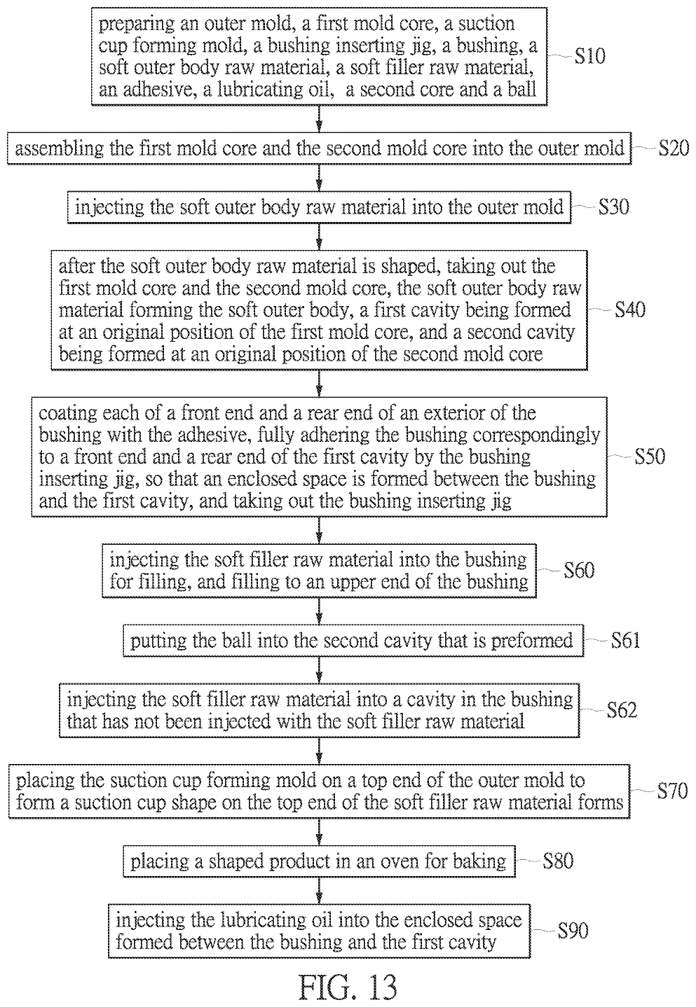

Embodiment 3 is shown in FIG. 13.

The method in the present embodiment includes step S10: preparing an outer mold, a first mold core, a suction cup forming mold, a bushing inserting jig, a bushing, a soft outer body raw material, a soft filler raw material, an adhesive, a lubricating oil, a second mold core, and a ball; step S20: assembling the first mold core and the second mold core into the outer mold; step S30: injecting the soft outer body raw material into the outer mold; step S40: after the soft outer body raw material is shaped, taking out the first mold core and the second mold core, the soft outer body raw material forming a soft outer body, a first cavity is formed at an original position of the first mold core, and a second cavity is formed at an original position of the second mold core; step S50: coating each of a front end and a rear end of an exterior of the bushing with the adhesive, fully adhering the bushing correspondingly to a front end and a rear end of the first cavity through the bushing inserting jig, so that an enclosed space is formed between the bushing and the first cavity, and taking out the bushing inserting jig; step S60: injecting the soft filler raw material into the bushing for filling; step S61: putting the ball into the second cavity that is preformed; step S62: injecting the soft filler raw material into a cavity in the bushing that has not been injected with the soft filler raw material; step S70: placing the suction cup forming mold on a top end of the outer mold to form a suction cup shape on the top end of the soft filler raw material; step S80: placing a shaped product in an oven for baking; and step S90: injecting the lubricating oil into the enclosed space formed between the bushing and the first cavity.

More specifically, in step S80: a baking temperature is 85 degrees Celsius. In other embodiments, the baking temperature can also be 80 degrees Celsius, 90 degrees Celsius, etc., preferably within the closed range of 80 degrees Celsius to 90 degrees Celsius.

In order to be able to inject lubricating oil into the enclosed space formed between the bush and the first cavity through a pinhole, the pinhole is firstly provided on the bushing. Of course, in other embodiments, the pinholes can also be provided on the first cavity.

On this basis, the pinhole can also be enclosed, and it is not necessary to perform the process of enclosing when it is hot.

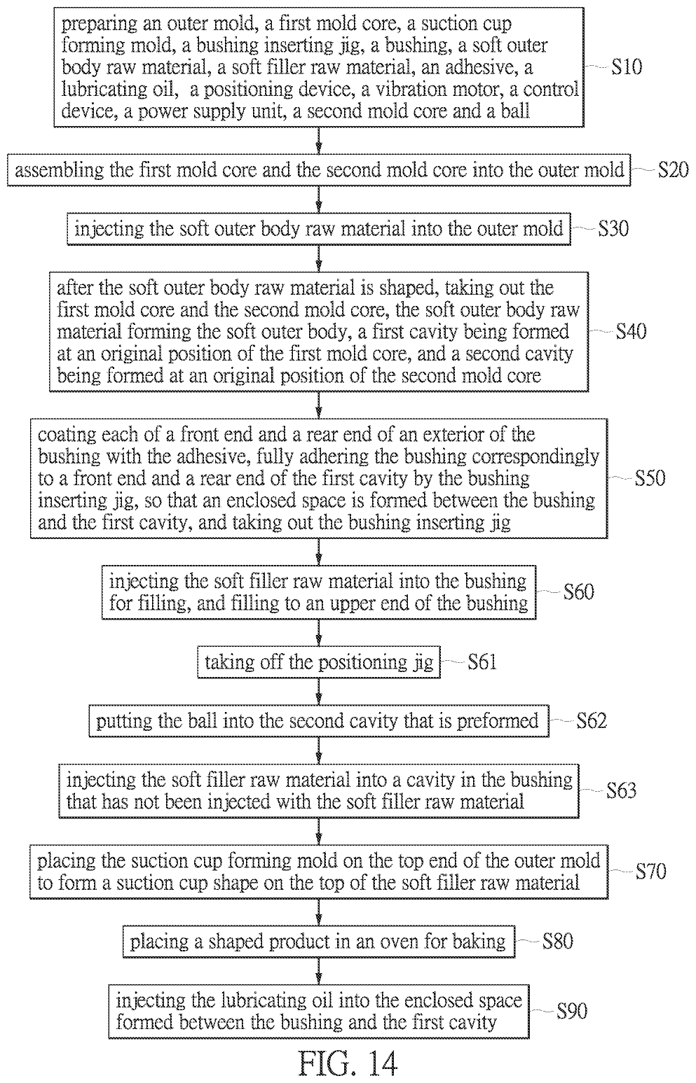

Embodiment 4 is shown in FIG. 14.

The method in the present embodiment includes step S10: preparing an outer mold, a first mold core, a suction cup forming mold, a bushing inserting jig, a bushing, a soft outer body raw material, a soft filler raw material, an adhesive, a lubricating oil, a positioning device, a vibration motor, a control device, a power supply unit, a second mold core, and a ball; step S20: assembling the first mold core and the second mold core into the outer mold; step S30: injecting the soft outer body raw material into the outer mold; step S40: after the soft outer body raw material is shaped, taking out the first mold core and the second mold core, the soft outer body raw material forming a soft outer body, a first cavity is formed at an original position of the first mold core, and a second cavity is formed at an original position of the second mold core; step S50: coating each of a front end and a rear end of an exterior of the bushing with the adhesive, fully adhering the bushing correspondingly to a front end and a rear end of the first cavity by the bushing inserting jig, so that an enclosed space is formed between the bushing and the first cavity, and taking out the bushing inserting jig; step S51: assembling the vibration motor, the control device, and the power supply unit to a lower side of a positioning jig, and placing the positioning jig on a top end of the outer mold, so that the vibration motor, the control device, and the power supply unit are placed in the bushing without contacting with the bushing; step S60: injecting the soft filler raw material into the bushing for filling, and filling to an upper end of the bushing; step S61: removing the positioning jig; step S62: putting the ball into the second cavity that is preformed; step S63: injecting the soft filler raw material into a cavity in the bushing that has not been injected with the soft filler raw material; step S70: placing the suction cup forming mold on the top end of the outer mold to form a suction cup shape on the top end of the soft filler raw material; step S80: placing a shaped product in an oven for baking; and step S90: injecting the lubricating oil into the enclosed space formed between the bushing and the first cavity.

More specifically, in step S80: a baking temperature is 85 degrees Celsius. In other embodiments, the baking temperature can also be 80 degrees Celsius, 90 degrees Celsius, etc., preferably within the closed range of 80 degrees Celsius to 90 degrees Celsius.

In order to be able to inject lubricating oil into the enclosed space formed by the bush and the first cavity through a pinhole, the pinhole is firstly provided on the bushing. Of course, in other embodiments, the pinhole can also be provided on the first cavity.

On this basis, the pinhole can also be enclosed, and it is not necessary to perform the process of enclosing when it is hot.

In the above four embodiments, the bushing is made by a bushing mold.

Embodiment 1 is the basic product, embodiment 2 is the product with vibration, embodiment 3 is the product with the ball, and embodiment 4 is the product with the vibration and the ball.

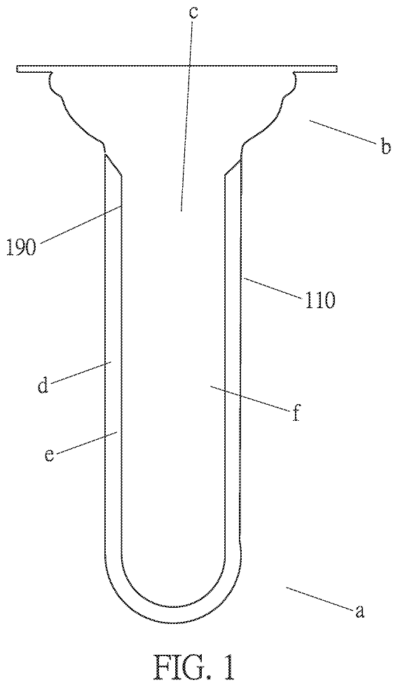

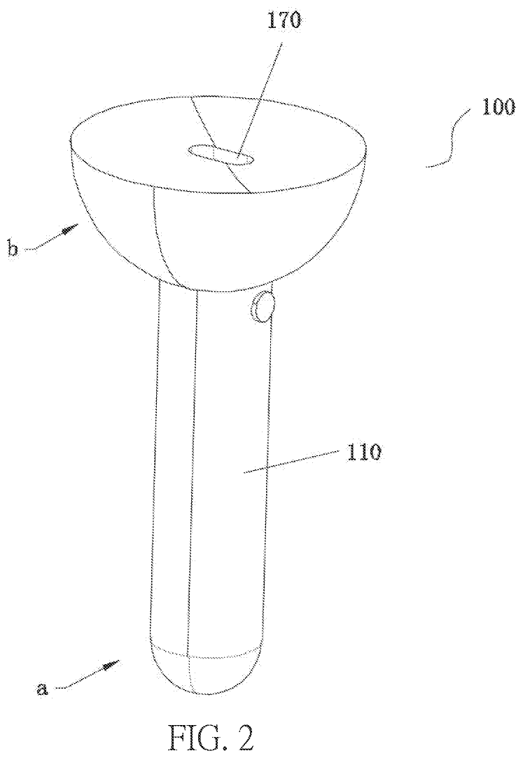

As shown in FIG. 1 and FIG. 2, a bottom end of the outer mold 200 corresponds to a massage end a of a massage device 100, and the top end of the outer mold 200 corresponds to a handheld end b of the massage device 100.

The introduction of each mold is as follows.

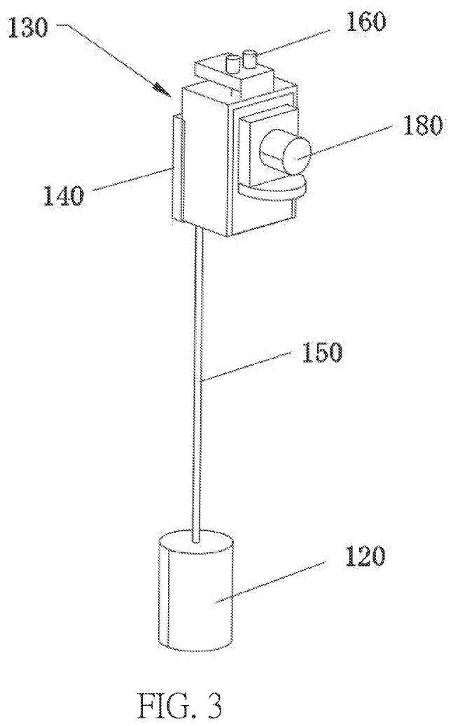

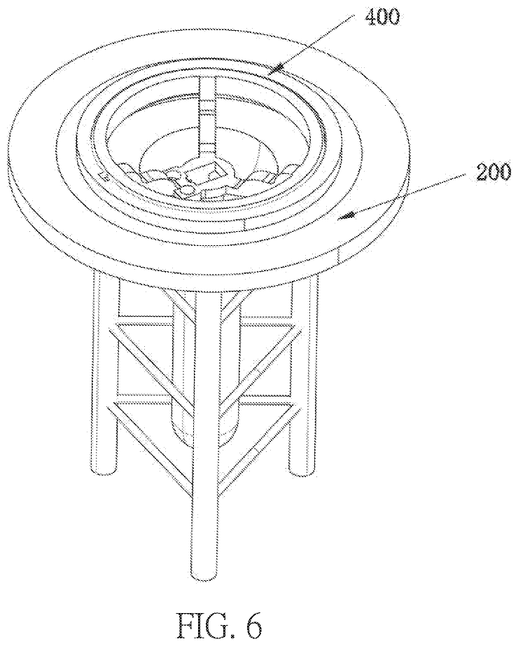

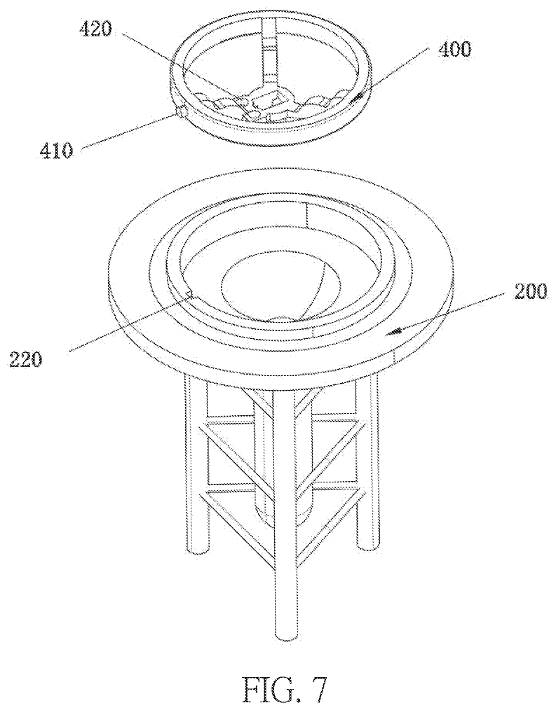

Reference is made to FIG. 3, FIG. 6 and FIG. 7, in which a control device 130 is assembled to a lower side of a positioning jig 400, a vibration motor 120 is connected to a lower side of the control device 130 through a wire 150, and a power supply unit 140 is fixedly assembled on the control device 130.

Further, a charging electrode 160 is provided on the control device 130. The positioning jig 400 is provided with a positioning structure 420 so that the control device 130 can be detachably assembled on the lower side of the positioning jig 400, and the charging electrode 160 is kept facing the top end of the outer mold 200 to facilitate subsequent charging of the massage device 100. In addition, the control device 130 is provided with a push switch 180, and the push switch 180 faces a side of the outer mold 200. The positioning jig 400 can facilitate the placement the vibration motor 120, the control device 130 and the power supply unit 140 in the bushing 190 of the massage device 100 according to a set position, and allow the charging electrode 160 to face the top end of the outer mold 200, and the push switch 180 face the side of the outer mold 200.

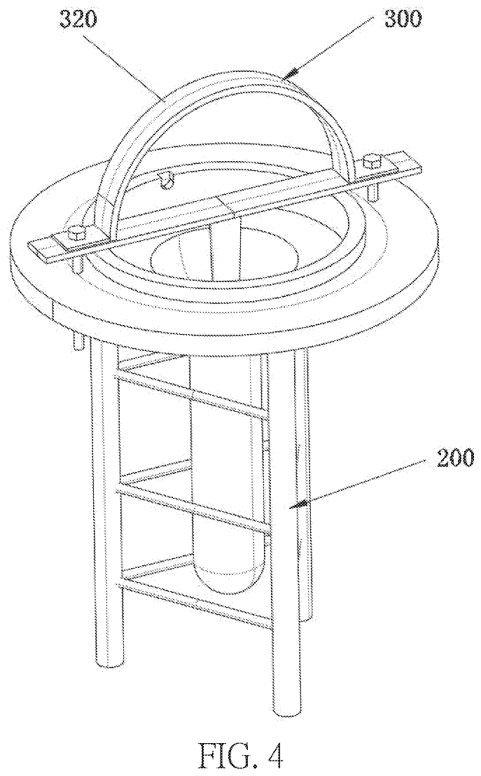

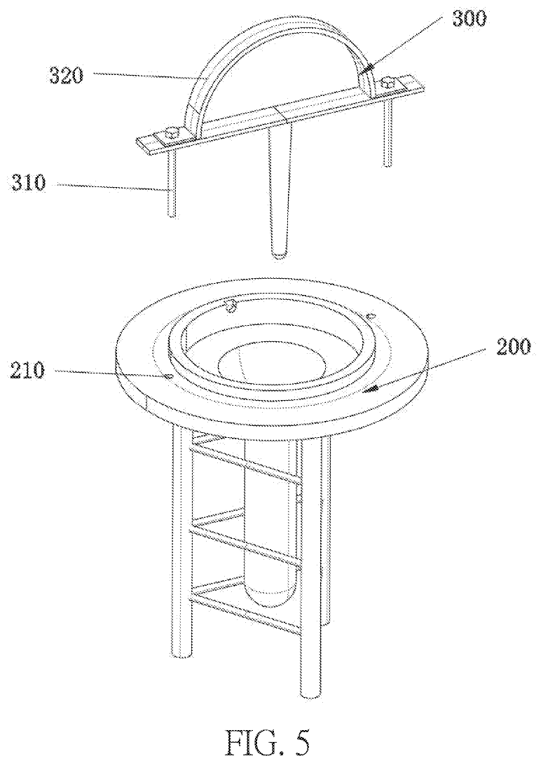

More specifically, as shown in FIG. 4 and FIG. 5, a top side of the outer mold 200 is provided with an insertion hole 210, and a lower side of the first mold core 300 is provided with an insert post 310, and the insert post 310 is detachably inserted into the insertion hole 210. A cooperation between the insertion hole 210 and the insert post 310 not only makes the outer mold 200 and the first mold core 300 detachable, but also positions the first mold core 300. In addition, a first handle 320 is provided on the top side of the first mold core 300 to facilitate taking out the first mold core 300. As shown in FIG. 6 and FIG. 7, a notch 220 is formed on the top side of the outer mold 200, and a first protrusion 410 protruding outward and corresponding to the notch 220 is provided on the positioning jig 400. By providing the notch 220 and the first protrusion 410, a direction of the positioning jig 400 is fixed, so that both a position direction of the vibration motor 120 and a position direction of the push switch 180 are at set positions.

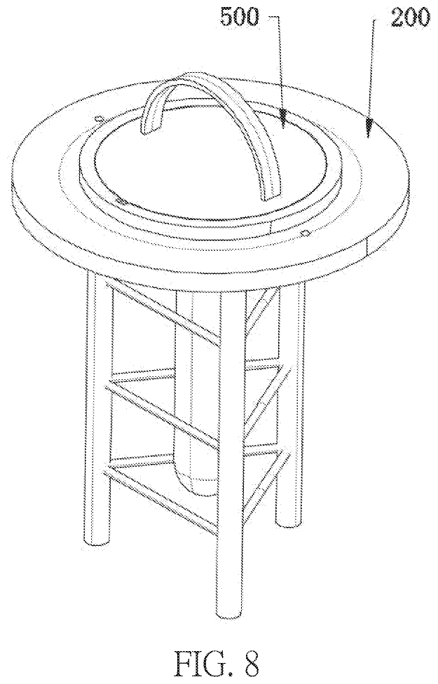

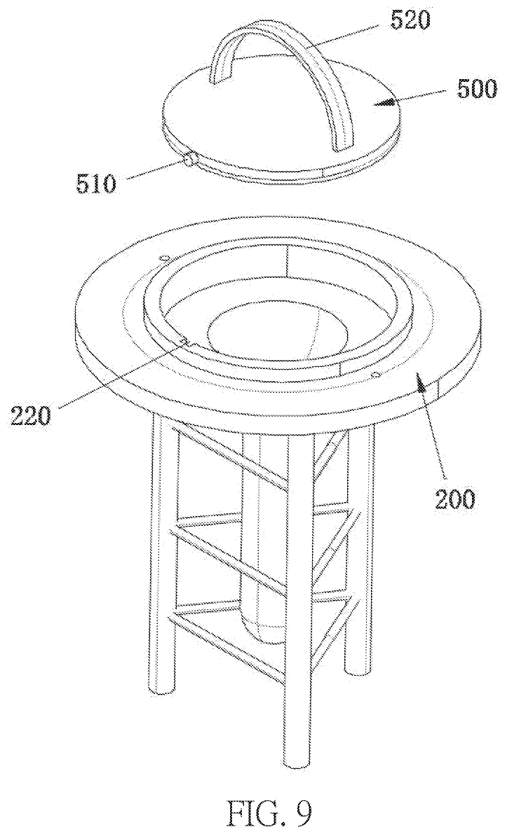

Further, as shown in FIG. 8 to FIG. 10, a suction cup forming mold 500 is provided with a second protrusion 510 protruding outward and corresponding to the notch 220. By providing the second protrusion 510, the direction of the suction cup forming mold 500 is fixed. A second handle 520 is provided on the top side of the suction cup forming mold 500 to facilitate taking out the suction cup forming mold 500.

Furthermore, a bottom end of the suction cup forming mold 500 is provided with a third protrusion 530, so that after the suction cup forming mold 500 is placed on the top end of the outer mold 200, a charging port 170 is formed on the handheld end b of the massage device 100, and a position of the charging port 170 corresponds to a position of the charging electrode 160.

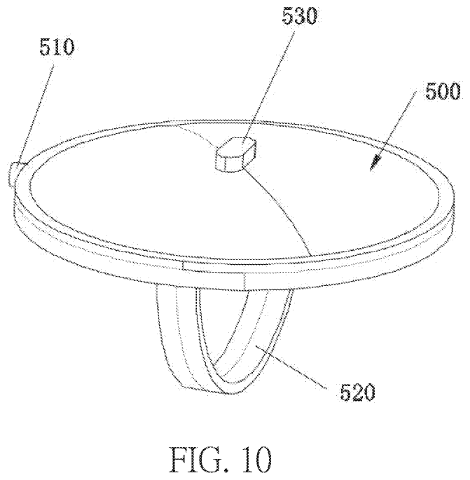

Furthermore, as shown in FIG. 10 and FIG. 2, the bottom end of the suction cup molding die 500 is in an arc shape protruding outward, so that after molding, the bottom end of the hand-held end b of the massage device 100 is in an arc shape protruding inward.

The second mold core (not shown) includes a frame body (not shown) for erecting on the upper side of the outer mold, and a knot protrusion structure (not shown) arranged on the frame body for forming the second cavity.

The massage device 100 manufactured by the manufacturing method in embodiment 1 is taken as an example. Reference is made to FIG. 1, in which the massage device 100 includes: a soft outer body 110, a bushing 190, adhesive members, a lubricating oil layer e, and a soft filler f. The soft outer body 110 has a first cavity c. The bushing 190 is disposed in the first cavity c, and an enclosed space d is formed between its exterior and the first cavity c. There are two adhesive parts, one is adhered between a front end of the exterior of the bushing 190 and the first cavity c, and the other is adhered between the rear end of the exterior of the bushing 190 and the first cavity c, thereby forming the above-mentioned enclosed space d. The lubricating oil layer e is filled in the enclosed space d; the soft filler f is filled in the bushing 190. By providing the bushing 190, the bushing 190 is fully adhered to a front end and a rear end of the first cavity c, so that the enclosed space d is formed between the bushing 190 and the first cavity c, and lubricating oil is injected into the bushing 190 after molding. In the enclosed space d formed between the sleeve 190 and the first cavity c, the lubricating oil layer e is formed, which greatly improves the massage effect and brings users a better experience.

The massage device 100 manufactured by the manufacturing method in embodiment 2 is taken as an example. Reference is made to FIG. 2 and FIG. 3, in which the massage device 100 further includes: a vibration motor 120, a control device 130 and a power supply unit 140. The vibration motor 120 is located within the bushing 190. The control device 130 is located in the bushing 190 and electrically connected to the vibration motor 120, and configured to control the vibration motor 120 to operate. The power supply unit 140 is located in the bushing 190 and electrically connected to the control device 130 for supplying power to the vibration motor 120 and the control device 130. The soft filler f encloses the vibration motor 120, the control device 130 and the power supply unit 140 in the bushing 190. By assembling the vibration motor 120, the control device 130 and the power supply unit 140 on the lower side of the positioning jig 400, and placing the positioning jig 400 on the top end of the outer mold 200, the vibration motor 120, the control device 130 and the power supply unit 140 are set according to the set position. The position is located in the bushing 190, so that the bushing 190 of the massage device 100 does not need a housing or bracket, which greatly reduces a foreign body feeling of the product and improves the user experience.

The massage device 100 manufactured by the manufacturing method in embodiment 3 is taken as an example. The soft outer body 110 has a second cavity. The massage device 100 also includes a ball located in the second cavity. By being provided with spherical objects, more experience can be brought to users.

The above is only used to illustrate the technical solution of the present disclosure and not to limit it. Other modifications or equivalent replacements made by those skilled in the art to the technical solution of the present disclosure, as long as they do not deviate from the spirit and scope of the technical solution of the present invention, shall be covered by the claims of the present disclosure.

What is claimed is:

1. A manufacturing method of massage device, comprising the following steps:
S10: preparing an outer mold, a first mold core, a suction cup forming mold, a bushing inserting jig, a bushing, a soft outer body raw material, a soft filler raw material, an adhesive, and a lubricating oil;
S20: assembling the first mold core into the outer mold;
S30: injecting the soft outer body raw material into the outer mold;
S40: after the soft outer body raw material is shaped, taking out the first mold core, the soft outer body raw material forming a soft outer body, and a first cavity is formed at an original position of the first mold core;
S50: coating each of a front end and a rear end of an exterior of the bushing with the adhesive, fully adhering the bushing correspondingly to a front end and a rear end of the first cavity through the bushing inserting jig, so that an enclosed space is formed between the bushing and the first cavity, and taking out the bushing inserting jig;
S60: injecting the soft filler raw material into the bushing for filling;
S70: placing the suction cup forming mold on a top end of the outer mold to form a suction cup shape on a top end of the soft filler raw material;
S80: placing a shaped product in an oven for baking; and
S90: injecting the lubricating oil into the enclosed space formed between the bushing and the first cavity.

2. The manufacturing method of the massage device according to claim 1, wherein step S10 further includes: preparing a positioning device, a vibration motor, a control device, and a power supply unit;
wherein the method further includes step S51 between step S50 and step S60,
S51: assembling the vibration motor, the control device, and the power supply unit to a lower side of a positioning jig, and placing the positioning jig on the top end of the outer mold, so that the vibration motor, the control device, and the power supply unit are placed in the bushing without contacting with the bushing; and
wherein the method further includes step S61 between step S60 and step S70,
S61: taking off the positioning jig.

3. The manufacturing method of the massage device according to claim 1, wherein step S10 further includes: preparing a second mold core and a ball;
in step S20: assembling the first mold core and the second mold core into the outer mold;
in step S40: after the soft outer body raw material is shaped, taking out the first mold core and the second mold core, the soft outer body raw material forming the soft outer body, the first cavity being formed at an original position of the first mold core, and a second cavity being formed at an original position of the second mold core;
in step S60: injecting the soft filler raw material into the bushing for filling, and filling to an upper end of the bushing;
wherein the method further includes step S61 and step S62 between step S60 and step S70,
S61: putting the ball into the second cavity that is preformed; and
S62: injecting the soft filler raw material into a cavity in the bushing that has not been injected with the soft filler raw material.

4. The manufacturing method of the massage device according to claim 1, wherein step S10 further includes: preparing a positioning device, a vibration motor, a control device, a power supply unit, a second mold core and a ball;
in step S20: assembling the first mold core and the second mold core into the outer mold;
in step S40: after the soft outer body raw material is shaped, taking out the first mold core and the second mold core, the soft outer body raw material forming the soft outer body, the first cavity being formed at an original position of the first mold core, and the second cavity being formed at an original position of the second mold core;
wherein the method further includes step S51 between step S50 and step S60,
S51: assembling the vibration motor, the control device, and the power supply unit to a lower side of a positioning jig, and placing the positioning jig on the top end of the outer mold, so that the vibration motor, the control device, and the power supply unit are placed in the bushing without contacting with the bushing;
in step S60: injecting the soft filler raw material into the bushing for filling, and filling to an upper end of the bushing;
wherein the method further includes step S61, step S62 and step S63 between step S60 and step S70,
S61: removing the positioning jig;
S62: putting the ball into the second cavity that is preformed; and
S63: injecting the soft filler raw material into a cavity in the bushing that has not been injected with the soft filler raw material.

5. The manufacturing method of the massage device according to claim 1, wherein in step S80, a baking temperature is 80 degrees Celsius to 90 degrees Celsius.

6. The manufacturing method of the massage device according to claim 1, wherein step S90 further includes: providing pinholes on the bushing or the first cavity, and injecting the lubricating oil into the enclosed space formed between the bushing and the first cavity through the pinholes.

7. The manufacturing method of the massage device according to claim 6, further including: S100: enclosing the pinholes.

8. The manufacturing method of the massage device according to claim 1, wherein the bushing is made of a bushing mold.

9. The manufacturing method of the massage device according to claim 2, wherein a bottom end of the outer mold corresponds to a massage end of the massage device, and the top end of the outer mold corresponds to a handheld end of the massage device;
wherein the control device is assembled to the lower side of the positioning jig, the vibration motor is connected to a lower side of the control device through wires, and the power supply unit is fixedly assembled on the control device;
wherein the control device is provided with a charging electrode, and the charging electrode faces the top end of the outer mold; and
wherein the control device is provided with a push switch, and the push switch faces a side of the outer mold.

10. The manufacturing method of the massage device according to claim 9, wherein the positioning jig is provided with a positioning structure, so that the control device is detachably assembled on the lower side of the positioning jig, and maintains the charging electrode facing the top end of the outer mold.

11. The manufacturing method of the massage device according to claim 1, wherein a top side of the outer mold is provided with a socket, a lower side of the first mold core is provided with an insert post, and the insert post is detachably inserted into the socket; and
wherein a notch is provided on the top side of the outer mold, and a first protrusion protruding outward and corresponding to the notch is provided on the positioning jig.

12. The manufacturing method of the massage device according to claim 11, wherein a first handle is provided on a top side of the first mold core.

13. The manufacturing method of the massage device according to claim 11, wherein the suction cup forming mold is provided with a second protrusion protruding outward and corresponding to the notch, and a top side of the suction cup forming mold is provided with a second handle.

14. The manufacturing method of the massage device according to claim 13, wherein a bottom end of the suction cup forming mold is provided with a third protrusion, so that after the suction cup forming mold is placed on the top end of the outer mold, a charging port is formed on a handheld end of the massage device, and the charging port corresponds to a charging electrode.

15. The manufacturing method of the massage device according to claim 14, wherein the bottom end of the suction cup forming mold is in an arc shape protruding outward, so that a bottom end of the handheld end of the massage device is in an arc shape protruding inward.

16. The manufacturing method of the massage device according to claim 3, wherein the second mold core includes a frame body for erecting on an upper side of the outer mold and a knot protrusion structure arranged on the frame body for forming the second cavity.

17. A massage device manufactured according to the manufacturing method of the massage device as claimed in claim 1.

18. The massage device according to claim 17, comprising:
the soft outer body having the first cavity;
the bushing disposed in the first cavity, wherein the enclosed space is formed between an exterior of the bushing and the first cavity;
two adhesive members, wherein one adhesive member is adhered between the front end of the exterior of the bushing and the first cavity, and another adhesive member is adhered between the rear end of the exterior of the bushing and the first cavity;
a lubricating oil layer filled in the enclosed space; and
a soft filler filled in the bushing.

19. The massage device according to claim 18, further comprising:
a vibration motor located in the bushing;
a control device located in the bushing and electrically connected to the vibration motor, and configured to control operation of the vibration motor; and
a power supply unit located in the bushing and electrically connected to the control device, and configured to supply power correspondingly to the vibration motor and the control device;
wherein the soft filler encloses the vibration motor, the control device and the power supply unit in the bushing.

20. The massage device according to claim 18, wherein the soft outer body is provided with the second cavity, and the massage device further includes the ball located in the second cavity.
